(19) United States
(12) Patent Application Publication
(10) Pub. No.: US 2002/0049681 A1
(43) Pub. Date: Apr. 25, 2002

(54) Secure anonymous verification, generation and/or proof of ownership of electronic receipts

(75) Inventor: Elsie Van Herreweghen, Adliswil (CH)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 09/899,444

(22) Filed: Jul. 5, 2001

(30) Foreign Application Priority Data
Jul. 20, 2000 (EP) 00115620.7

(51) Int. Cl. H04K 1/00; G06F 17/60

(52) U.S. Cl. 705/64

(57) ABSTRACT

A method, apparatus and system is provided for secure anonymous proof of ownership of electronic receipts, wherein a sender sends a first message including a transaction request and referencing an owner of a receipt to be generated to a first addressee. The first addressee returns a signed receipt including the reference and details for what the receipt has been given. The sender sends a signed second message including the receipt to a second addressee. The second addressee obtains a public signature verification key on the basis of the reference to the owner of the receipt and authenticates the second message. A major advantage of the invention is that in a pseudonymous or anonymous transaction based system it is now possible to remain anonymous or pseudonymous when presenting electronic receipts, while securely proving ownership of the receipt.

### FIELD OF THE INVENTION

The present invention relates to the field of computer network management. It specifically concerns secure data exchange over a computer network. More particularly, the present invention relates to securely proving ownership of pseudonymous or anonymous electronic receipts.

### BACKGROUND OF THE INVENTION

Since the mid 1990s one of the most rapidly growing retail sectors is referred to as electronic commerce. Electronic commerce involves the use of the Internet and proprietary networks to facilitate business-to-business, consumer, and auction sales of everything imaginable, from computers and electronics to books, recordings, automobiles, and real estate. In such an environment consumer privacy is becoming a major concern.

However, the mere fact that electronic commerce is conducted over an existing open network infrastructure such as the Internet runs counter to the privacy of the consumer. Often, there are legitimate reasons for a party to remain anonymous.

A method is known from U.S. Pat. No. 6,061,789, for anonymous, provable information exchange between a sender and an addressee in a computer network. The computer network providing a public key infrastructure, advantageously with certification, and an anonymous communication channel available between network users. The sender composes an offer request with a subject or merchandise description and a digital signature of the sender. The request is transmitted via the anonymous communication channel to at least one addressee. The addressee composes a reply with an offer description and its digital signature, the digital signature being computed over a selection of quantities comprising at least one of merchandise description, offer description, signature of sender, and further including the addressee's public key or public key certificate. Upon receiving the reply the sender uses the merchants public key, known, transmitted, or extracted from the public key certificate, to encrypt the received digital signature of the merchant, thus determining a first temporary value, the sender computes a concatenation of the selection of quantities on which the merchant's signature is based, thus determining a second temporary value. The sender compares the temporary values, whereby a match indicates genuineness of the offer. Moreover, the merchant is able to make sure that the offer and the merchandise are given to the same consumer, i.e., the customer cannot freely transfer the offer to another consumer. This entails the consumer to reveal his or her identity to the merchant, but only when the consumer is ready to purchase the merchandise, but not before.

### SUMMARY OF THE INVENTION

It is therefore an aspect of the present invention to provide methods, apparatus and systems for securely proving ownership of pseudonymous or anonymous electronic receipts, wherein a party that proves its ownership of the receipt can stay anonymous, i.e., it does not need to reveal its identity.

The foregoing aspect is achieved by a method, apparatus and system as described and claimed. Further aspects and advantageous embodiments of the present invention are described and taught in the following description. The aspects, features and advantages of the present invention, will be apparent in the following detailed written description.

Since more than one party is generally involved in the communication and the exchange of data in accordance with the present invention, parts of the description and some of the claims take the perspective of each of the different participants.

### BRIEF DESCRIPTION OF THE DRAWINGS

The novel features of the invention are set forth in the description and the appended claims. The invention itself, however, as well as a advantageous mode of use, further aspects, and advantages thereof, will best be understood by reference to the following detailed description of an illustrative embodiment when read in conjunction with the accompanying drawings, wherein:

FIG. 1 shows a general layout of a communication environment in which the invention can be used;

FIG. 2 shows a data exchange according to a first embodiment of the present invention;

FIG. 3 shows a data exchange according to a second embodiment of the present invention;

FIG. 4 shows a data exchange according to a third embodiment of the present invention;

FIG. 5 shows a data exchange according to a fourth embodiment of the present invention; and

FIG. 6 shows a data exchange according to a fifth embodiment of the present invention.

### DETAILED DESCRIPTION OF THE INVENTION

As the collection and exploitation of private information become more of a concern, users are less willing to give out information, and may want to conduct transactions under a pseudonym or anonymously. For example, a user in a pseudonymous or anonymous transaction may receive a receipt of the transaction, e.g., a receipt of a payment. The user might want to use the receipt at a later point in time or several times in the future to prove that the particular transaction took place, e.g., that the user made a payment.

The methods apparatus and systems for proving ownership of an electronic receipt in accordance with the present invention is to be used in a communication system providing a public key encryption infrastructure. That is a system of public key encryption using digital certificates from certificate authorities and other registration authorities that verify and authenticate the validity of each party involved in an electronic transaction. The certificate authority, also called “Trusted Third Party”, is an entity, typically a company, that issues digital certificates to other entities like organizations or individuals to allow them to prove their identity to others. The certificate authority might be an external company that offers digital certificate services or it might be an internal organization such as a corporate MIS (Management Information System) department. The Certificate Authority's chief function is to verify the identity of entities and issue digital certificates attesting to that identity.

In comparison, public key encryption is an encryption scheme, where each person gets a pair of keys, called the public key and the private key. Each person's public key is published while the private key is kept secret. Messages are encrypted using the intended recipient's public key and can only be decrypted using his private key. This is mechanism can also be used for or in conjunction with a digital signature.

The digital signature is formed by extra data appended to a message which identifies and authenticates the sender and message data using public-key encryption. The sender uses a one-way hash function to generate a hash-code of, for example, 32 bits from the message data. He then encrypts the hash-code with his private key. The receiver computes the hash-code from the data as well and decrypts the received hash with the sender's public key. If the two hash-codes are equal, the receiver can be sure that data has not been corrupted and that it came from the given sender.

The need for sender and receiver to share secret information, e.g., keys, via some secure channel is eliminated, since all communications involve only public keys, and no private key is ever transmitted or shared. Public-key encryption can be used for authentication, confidentiality, integrity and non-repudiation. RSA encryption is an example of a public-key cryptography system.

The one-way hash function, also called “message digest function”, used for the digital signature is a function which takes a variable-length message and produces a fixed-length hash. Given the hash it is computationally impossible to find a message with that hash. In fact, one cannot determine any usable information about a message with that hash, not even a single bit. For some one-way hash functions it is also computationally impossible to determine two messages which produce the same hash. A one-way hash function can be private or public, just like an encryption function. A public one-way hash function can be used to speed up a public-key digital signature system. Rather than signing a long message which can take a long time, the one-way hash of the message is computed, and the hash is digitally signed.

The method and system according to the present invention works as follows: A sender creates a first message to be sent to a first addressee including a transaction request and a reference to a designated owner of a receipt to be generated in response of receiving the message. The sender signs the message using a first secret signature key and sends it to the first addressee.

The first addressee receives the message from the sender and authenticates it using a public signature verification key associated to the secret signature key held by the sender of the message. Then the first addressee issues a receipt including the reference to the designated owner of the receipt and details for what the receipt has been given and signs the receipt with a public signature key assigned to the first addressee issuing the receipt. Finally, the first addressee returns the receipt to the sender of the message.

In response, the sender receives the receipt from the first addressee. In case the sender is different from the designated owner of the receipt, the receipt is transferred from the sender to the designated owner. However, in order to prove ownership the sender, in case he is the designated owner, or the designated owner himself composes a second message including the receipt, signs it using a second secret signature key and sends it to a second addressee.

The second addressee, in return, receives the second message from the sender, obtains a public signature verification key on the basis of the reference to the owner of the receipt and examines whether or not the secret signature key used for signing the second message is associated to the public signature verification key obtained on the basis of the reference to the owner of the receipt. In case of match the second addressee can be sure that he received the receipt from the owner of the receipt. However, the first and second addressee can also be the same party.

A major advantage of the method and system in accordance with the present invention is that in a pseudonymous or anonymous transaction based system it is now possible to remain anonymous or pseudonymous when presenting electronic receipts, while securely proving ownership of the receipt. Another advantage is that the inventive method and system can as well be implemented in existing communication networks providing a public key encryption infrastructure, such as the Internet.

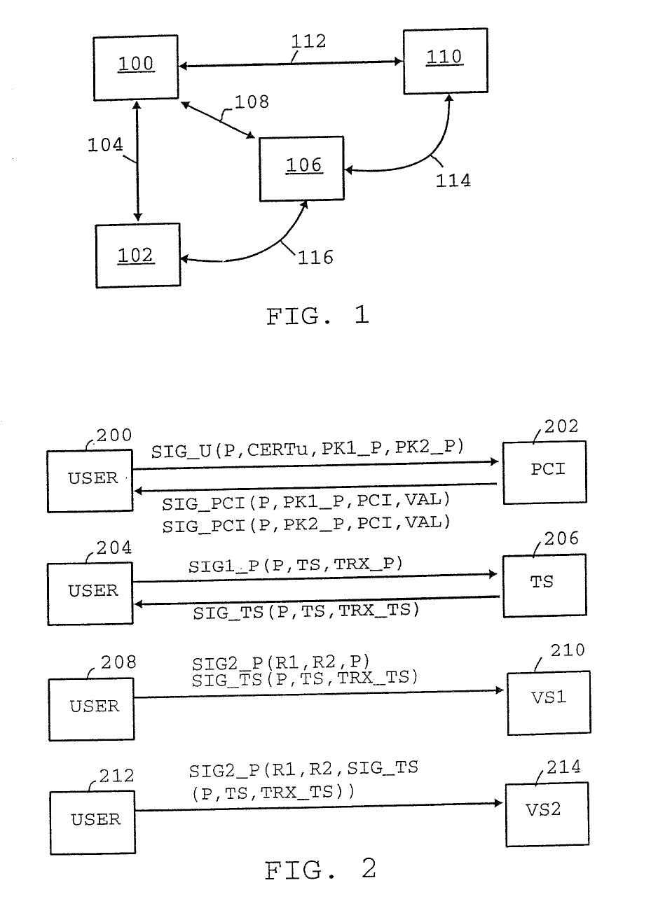

With reference to FIG. 1, the general layout of a communication environment is described in which the invention can be used. A user 100 is able to communicate with a transaction server 102 over a communication connection 104. It is assumed that the user possesses long-term credentials, such as a secret key SKu, a public key PKu and a public key certificate CERTu that allows the user 100 to prove his identity to others. The long term credentials are linked to the user 100 over a long time, e.g., lifetime. Generally, they can be used for transactions as well, though, not providing anonymity or allowing pseudonymous transactions.

Now, in a pseudonymous or anonymous setting in accordance with the present invention, a Pseudonym Certificate Issuer (PCI) 106 is established for granting short-lived pseudonymous certificates for users. In the present case, the user 100 requests a short-lived pseudonymous certificate for a pseudonym P over a communication connection 108 linking the user 100 to the PCI 106. In return, the PCI 106 grants a short-lived pseudonymous certificate CERTp for the user's 100 pseudonym P.

The needs for such a system in which the subject matter of the present invention might be used is most advantageous such when the system is secure, i.e., only the legitimate user 100 can get a pseudonym certificate and the linking between P and U can be revealed if necessary, e.g., in case of fraud, and the PCI 106 cannot falsely incriminate the user 100. Furthermore, user 100 can use receipts for transactions without revealing his identity. Although the system security, is important for the functioning of the overall system, it has to be acknowledged that there are known ways to ensure it. However, for the embodiments described it is assumed that such a secure system is implemented. Thus, the main focus is on the second issue, how to prove ownership of an electronic receipt without revealing identity.

Having the pseudonym P and the respective certificate CERTp the user 100 can now perform transactions with the transaction server 102 using the pseudonym P. A transaction request under the pseudonym P is signed with a respective secret key SKp. SKp may be known by either the PCI 106 or the user 100, depending on the role the PCI 106 plays in the pseudonymous system. The PCI 106 can, for example, act as the user's proxy by generating PKp and SKp and acting as the user 100. Alternatively, the user 100 generates the keys PKp and SKp and the PCI 106 issues the respective certificate CERTp for PKp.

For a pseudonymous transaction the user 100 sends the transaction request to the transaction server 102. The transactions requested can be any kind of business commonly referred to as electronic commerce.

Whereby, electronic commerce summarizes conducting of business communication and transactions over networks and through computers. As most restrictively defined, electronic commerce is the buying and selling of goods and services, and the transfer of funds, through digital communications. However electronic commerce also includes all intercompany and intra-company functions, such as marketing, finance, manufacturing, selling, and negotiation, that enable commerce and use electronic mail, file transfer, fax, video conferencing, workflow, or interaction with a remote computer. Electronic commerce also includes buying and selling over the World Wide Web and the Internet, electronic funds transfer, smart cards, digital cash, and all other ways of doing business over digital networks.

After the transaction server 102 concluded the transaction, a receipt is issued and returned to the user 100. Later when the user wants to prove to be the legitimate owner of the receipt, he sends a validation request and the receipt to a validation server 110 over a communication connection 112. It is understood that the transaction server 102 and the validation server 110 can belong to the same business entity or can even be implemented on the same computer system.

The transaction server 102 and the validation server 110 are also connected to the PCI 106 over communication connections 116 and 114. Over these connections the servers can obtain the respective certificate CERTp issued for the pseudonym P used by the user 100. Alternatively, the certificate CERTp can also be transmitted together with the transaction request and the validation request respectively.

Now with reference to FIG. 2, there is depicted the data exchange according to a first embodiment of the present invention. Block 200 illustrates a user and block 202 illustrates a Pseudonym Certificate Issuer (PCI) communicating with each other. First, the user requests a certificate from the PCI that is to be issued for a pseudonym P the user intends to use for future transactions. In the present case the user provides the pseudonym P to the PCI. However, it might be desirable to have the PCI not only issuing the certificates but also the pseudonyms. This can be advantageous if many users ask for the same pseudonym.

Furthermore, the user sends two public keys PK1_P and PK2_P to be linked to the pseudonym P. The two public keys PK1_P and PK2_P are associated to two private keys SK1_P and SK2_P the user keeps as a secret. The private keys are used to sign messages under the pseudonym P for initiating a transaction and for proving the ownership of a receipt to be issued in response to the transaction respectively.

In the present case it is advantageous to be able to link the pseudonym P to the user, e.g., to be able to track down fraudulent users. Therefore, the user is asked to transmit a certificate CERTu to the PCI which allows to verify the identity of the user. Hence, the message the user sends to the PCI includes the pseudonym P and the user's personal certificate CERTu and the two public keys PK1_P and PK2_P. In order to ensure that the message has not been altered or counterfeit, it is signed by the user using a personal secret key SK_U as indicated by SIG_U.

In response to the certificate request the PCI returns two certificates to the user. The certificates securely links the public keys PK1_P and PK2_P to the pseudonym P. The certificate further comprises the name of the issuer, here PCI, and validity information, e.g. an expiry date of the certificate. The contents of the certificate are of course signed by the PCI in order to ensure that the certificate has not been altered or counterfeit.

Focusing now on block 204, block 204 illustrates the user previously exchanging data with the PCI and block 206 illustrates a transaction server TS communicating with each other. The user intends to initiate a transaction. Therefore, the user creates a transaction request message. The transaction request message includes the transaction relevant data TRX_P, such as an order or purchase description, a specification of a payment method, an amount of money to be paid, a specification of the currency. Furthermore, the message includes the name of the addressee, here the transaction server TS, and the pseudonym P used by the user. Finally, the message is signed by the user using the private key SK1_P as indicated by SIG1_P.

In return, the transaction server performs the requested transaction, for example, accepts a payment. After concluding the transaction the transaction server TS issues a receipt acknowledging that the requested transaction has been performed. The receipt is a message signed by the issuer, here the transaction server TS as indicated by SIG_TS. The message includes transaction relevant data TRX_T composed by the transaction server TS, the pseudonym P used by the initiator of the request taken from the transaction request message and the issuer of the receipt, here the transaction server TS.

Next, the user wants to prove that he is the legitimate owner of the receipt received from the transaction server. Block 208 illustrates the user previously received the receipt and block 210 illustrates a validation server VS1 communicating to each other. First of all, the user sends the previously received receipt to the validation server VS1. Additionally, the user sends a message proving that he is acting legitimately using the pseudonym P. In fact, the user sends a message comprising the pseudonym P and two randomizer R1 and R2 that is signed with the private key SK2_P as indicated by SIG2_P.

In response, the validation server obtains the public key PK2_P either from the PCI or from a respective certificate securely linking the pseudonym P to the public key PK2_P (not shown). Using the public key PK2_P the validation server is able to authenticate whether or not the message has been signed by the user legitimately using the pseudonym P. This resulting from the fact that only the legitimate user knows the private key SK2_P that was used to sign the message. In order to ensure that the receipt itself has not been altered or counterfeit the transaction server authenticates the receipt as well using a certificate issued for the transaction server TS by a certificate authority or by obtaining the respective key directly from the transaction server TS.

Alternatively, the user only sends one message as depicted in the data exchange between block 212 illustrating the user owning the receipt and an alternative validation server VS2. In this case, the user composes a message consisting of the receipt previously received from the transaction server and two randomizer R1 and R2. The validation server again obtains the public key PK2_P to authenticate that the message has been send by the user being the legitimate owner of the pseudonym P.

The first embodiment can be implemented in communication networks by neither changing an existing transaction protocol nor changing the structure of a used certificate. Thus, the first embodiment is advantageously applied to environments in which a certificate CERTp issued for a pseudonym P has to comply with an existing certificate format, e.g., in case the format only allows one public key.

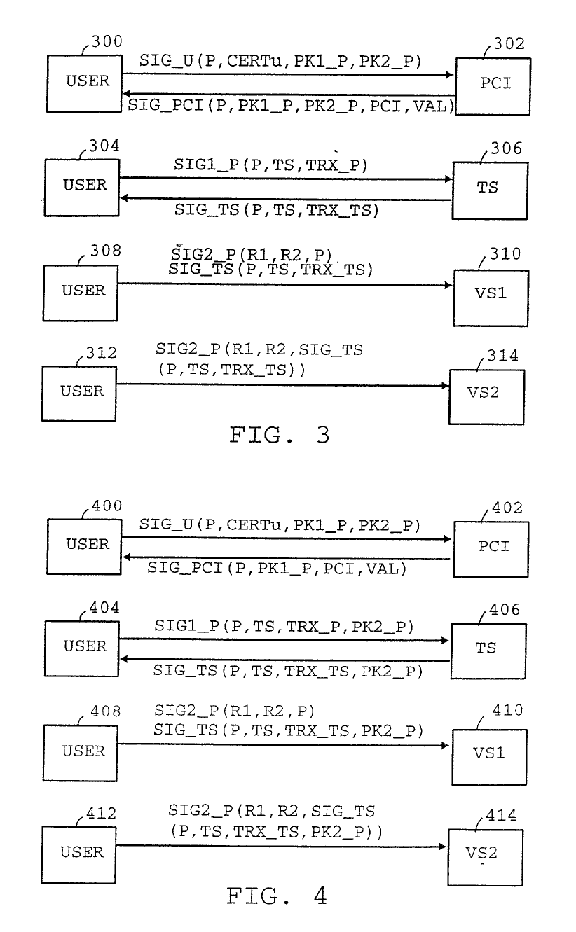

With reference now to FIG. 3, there is depicted a data exchange according to a second embodiment of the present invention. The second embodiment can advantageously be implemented in an environment in which only the format of the certificate can be changed, e.g., the certificate can include both public keys PK1_P and PK2_P, but no additional data can be added to the request message or the receipt message. Hence, the second public key PK2_P can be directly linked the pseudonym P using only one certificate.

Block 300 illustrates a user and block 302 illustrates a PCI as shown in FIG. 2. In response to a user's message requesting a pseudonymous certificate the PCI returns a certificate CERTp. The certificate CERTp securely links both public keys PK1_P and PK2_P to a pseudonym P used by the user. Further it includes information about the issuer, here the PCI, and validation information VAL.

With reference now to block 304 illustrating the user previously exchanging data with the PCI and block 306 illustrating a transaction server TS communicating with each other. The user creates a transaction request message including the transaction relevant data TRX_P, name of the addressee, here the transaction server TS, and the pseudonym P used by the user, signs the message and sends it to the transaction server TS.

After completing the transaction the transaction server TS returns a receipt acknowledging that the requested transaction has been performed. The receipt is a signed message comprising transaction relevant data TRX_T composed by the transaction server TS, the pseudonym P taken from the transaction request message and the name of the issuer of the receipt.

Block 308 illustrates the user previously received the receipt and block 310 illustrates a validation server VS1 communicating to each other. Whenever the user wants to prove ownership of the receipt the user sends the previously received receipt to the validation server VS1. Furthermore, the user sends a message proving that he is acting legitimately using the pseudonym P.

Using the public key PK2_P the validation server authenticates the message presenting the receipt as explained for the scenario of FIG. 2 in greater detail. Alternatively, the user only sends one message as depicted in the data exchange between block 312 illustrating the user owning the receipt and block 314 illustrating an alternative validation server VS2. Here, the user sends a signed message including the receipt previously received from the transaction server TS and two randomizers R1 and R2. Again using the public key PK2_P the validation server authenticates the message presenting the receipt as explained for the scenario shown in FIG. 2.

Next, focusing on FIG. 4, there is depicted a data exchange according to a third embodiment of the present invention. The third embodiment can advantageously be implemented in an environment in which only the transaction protocol is allowed to be changed, e.g., in case the certificate CERTp can only include one public key but additional data can be added to the request message and the receipt message respectively.

As in FIGS. 2 and 3, block 400 of FIG. 4 illustrates a user and block 402 illustrates a PCI. In response to a user's message requesting a pseudonymous certificate the PCI returns a certificate CERTp. In contrast to the embodiment shown in FIG. 3, the certificate CERTp securely links only the first public key PK1_P to a pseudonym P used by the user. Further it includes information about the issuer, here the PCI, and validation information VAL. Block 404 illustrates the user previously exchanging data with the PCI and block 406 illustrates a transaction server TS communicating with each other. The user creates a transaction request message including the transaction relevant data TRX_P, name of the addressee, here the transaction server TS, the pseudonym P used by the user and additionally the second public key PK2_P. Thereafter the user signs the message and sends it to the transaction server TS.

The transaction server TS returns a receipt acknowledging that the requested transaction has been performed. The receipt includes transaction relevant data TRX_T composed by the transaction server TS, the pseudonym P taken from the transaction request message, the name of the issuer of the receipt and additionally the second public key PK2_P also taken from the transaction request message. Herewith, the second public key PK2_P is actually linked to the pseudonym P used by the user.

Focusing now on block 408 depicting the user having previously received the receipt and block 410 depicting a validation server VS1 communicating to each other. Whenever the user wants to prove ownership of the receipt the user sends the previously received receipt to the validation server VS1. Additionally, the user sends a message proving that he is acting legitimately using the pseudonym P.

Using the public key PK2_P obtained together with the receipt the validation server authenticates the message presenting the receipt. Alternatively, the user only sends one message as depicted in the data exchange between block 412 illustrating the user owning the receipt and block 414 illustrating an alternative validation server VS2. Here, the user sends a signed message including the receipt previously received from the transaction server TS and two randomizers R1 and R2. Again using the public key PK2_P the validation server authenticates the message presenting the receipt as explained for the scenario shown in FIGS. 2 and 3.

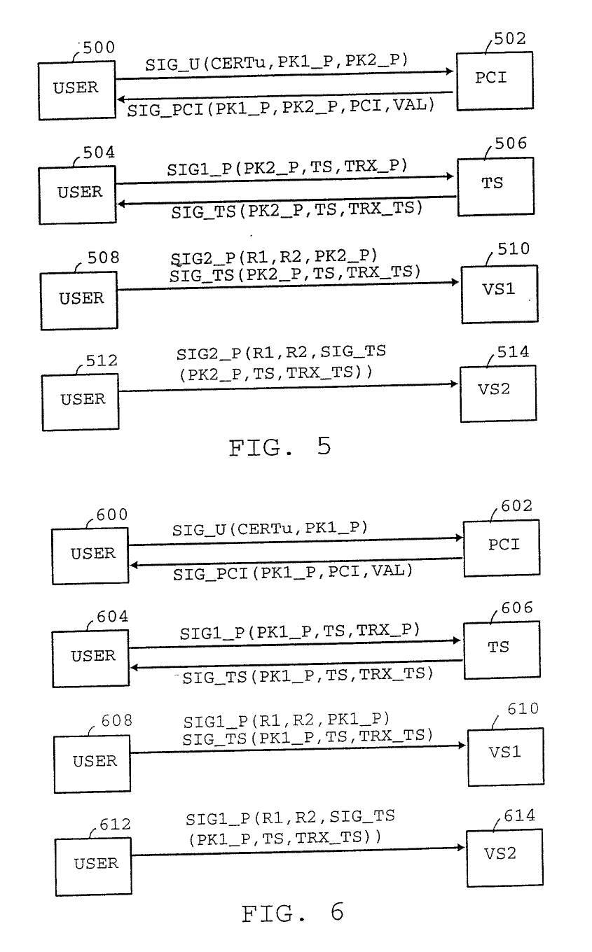

With reference now to FIG. 5, there is depicted a data exchange according to a fourth embodiment of the present invention. The fourth embodiment expects an environment providing complete freedom in the design of the certificate format and transaction protocol. Thus, the transaction protocol as well as the certificate format can be adapted. Furthermore, the fourth embodiment provides anonymity since all pseudonym identifiers have been removed. Therefore, the legitimate user is only identified by a public key. In other words, the user knowing the corresponding private key is the legitimate user of the respective receipt. Hence, the fourth embodiment provides anonymous certificates and transactions. However, in case the PCI only issues anonymous certificates for users providing a certificate CERTu to prove their real identity, it is still possible to track down fraudulent users.

Again block 500 illustrates a user and block 502 illustrates a PCI. In response to a user's message requesting a certificate the PCI returns a certificate CERTp. In contrast to the embodiment shown in FIG. 4, the certificate request only includes both public keys and the user's certificate CERTu. Thus, no pseudonym is provided to the PCI. The certificate CERTp securely links both public keys PK1_P and PK2_P together.

As in FIG. 4, block 504 illustrates the user previously exchanging data with the PCI and block 506 illustrates a transaction server TS communicating with each other. The user creates a transaction request message including the transaction relevant data TRX_P, the name of the addressee, here the transaction server TS and the second public key PK2_P. In contrast to the previously described embodiments the transaction request message does not contain a pseudonym P. The legitimate user is only referenced by the public key PK2_P. Thereafter the user signs the message and sends it to the transaction server TS.

The transaction server TS returns a receipt acknowledging that the requested transaction has been performed. The receipt includes transaction relevant data TRX_T composed by the transaction server TS, the name of the issuer of the receipt and the second public key PK2_P.

Block 508 depicts the user having previously received the receipt and block 510 depicting a validation server VS1 communicating to each other. Whenever the user wants to prove ownership of the receipt the user sends the previously received receipt to the validation server VS1. Additionally, the user sends a message proving that he is acting legitimately using the pseudonym P. The message includes two randomizers R1 and R2 and the second public key PK2_P.

Using the public key PK2_P obtained together with the receipt the validation server authenticates the message presenting the receipt. Alternatively, the user only sends one message as depicted in the data exchange between block 512 illustrating the user owning the receipt and block 514 illustrating an alternative validation server VS2. In this case, the user sends a signed message including the receipt previously received from the transaction server TS and two randomizers R1 and R2. Again using the public key PK2_P the validation server authenticates the message presenting the receipt.

Finally, with reference to FIG. 6, there is depicted a data exchange according to a fifth embodiment of the present invention. As the fourth embodiment, the fifth embodiment expects an environment providing complete freedom in the design of the certificate format and transaction protocol. Like the fourth embodiment, the fifth embodiment also provides anonymity since all pseudonym identifier has been removed. Additionally, the number of key pairs is reduced to one. Hence, only on public key is needed for initiating a transaction and proving ownership of a respective receipt issued in response to the transaction.

Therefore, the legitimate user is only identified by one single public key. In other words, the user knowing the corresponding private key is the legitimate user of the respective receipt. Hence, the fifth embodiment provides really anonymous certificates and transactions. However, in the present case the PCI is only necessary if it is desired to be able to track down fraudulent users. Since the only key used, does not need to be linked to a pseudonym or another key the PCI is in fact not necessary for the fifth embodiment.

Block 600 illustrates again a user and block 602 illustrates a PCI. In response to a user's message requesting a certificate the PCI returns a certificate CERTp. In contrast to the fourth embodiment shown in FIG. 5, the certificate request only includes one public key PK1_P and the user's certificate CERTu. Thus, no pseudonym is provided to the PCI.

As in FIG. 5, block 604 illustrates the user previously exchanging data with the PCI and block 606 illustrates a transaction server TS communicating with each other. The user creates a transaction request message including the transaction relevant data TRX_P, the name of the addressee, here the transaction server TS and the only public key PK1_P. The legitimate user is only referenced by the public key PK1_P. Thereafter the user signs the message and sends it to the transaction server TS.

The transaction server TS returns a receipt acknowledging that the requested transaction has been performed. The receipt includes transaction relevant data TRX_T composed by the transaction server TS, the name of the issuer of the receipt and the public key PK1_P.

Block 608 depicts the user having previously received the receipt and block 610 depicts a validation server VS1 communicating to each other. Whenever the user wants to prove ownership of the receipt the user sends the previously received receipt to the validation server VS1. Additionally, the user sends a message proving that he is acting legitimately using the pseudonym P. The message including two randomizers R1 and R2 and the public key PK1_P.

Using the public key PK1_P obtained together with the receipt the validation server authenticates the message presenting the receipt. Alternatively, the user only sends one message as depicted in the data exchange between block 612 illustrating the user owning the receipt and block 614 illustrating an alternative validation server VS2. In this case, the user send a signed message including the receipt previously received from the transaction server TS and two randomizer R1 and R2. Again using the public key PK1_P the validation server authenticates the message presenting the receipt.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after either or both of the following conversion to another language, code or notation, and/or reproduction in a different material form.

Thus the invention includes an article of manufacture comprising a computer usable medium having computer readable program code means embodied therein for causing a function described above. The computer readable program code means in the article of manufacture comprising computer readable program code means for causing a computer to effect the steps of a method of this invention.

Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention.

Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

Having thus described my invention, what I claim as new and desire to secure by Letters Patent is as follows:

1. A verification method comprising verifying ownership of an electronic receipt in a communication system providing a public key encryption infrastructure, including the steps of:
receiving a message from a sender, said message being electronically signed by said sender using a private signature key owned by said sender, said message includes a receipt which is electronically signed by an issuer having given said receipt using a private signature key assigned to said issuer, wherein said receipt includes details for what said receipt has been given and a reference to said owner of said receipt;
obtaining a public signature verification key on the basis of said reference to said owner of said receipt; and
examining whether or not said private signature key used for electronically signing said message is associated to said public signature verification key obtained on the basis of said reference to said owner of said receipt.

2. The method according to claim 1, wherein said reference to said owner of said receipt is a public signature verification key associated to a private signature key held by said owner of said receipt.

3. The method according to claim 1, wherein said reference to said owner of said receipt is a pseudonym used by said owner of the receipt.

4. The method according to claim 3, wherein obtaining said public signature verification key on the basis of said pseudonym used by said owner of said receipt includes getting a certificate securely linking said pseudonym to said public signature verification key.

5. The method according to claim 1, further comprising the step of authenticating said receipt using a public signature verification key assigned to said issuer of said receipt.

6. A receipt generation method, comprising generating an electronic receipt in a communication system providing a public key encryption system, including the steps of:
receiving a message from a sender, said message is electronically signed by said sender using a private signature key owned by said sender, whereby said message includes a transaction request and a reference to a designated owner of a receipt to be generated;
authenticating said message using a public signature verification key associated to said private signature key held by said sender of said message;
issuing a receipt including said reference to said designated owner of said receipt and details for what said receipt has been given; and
electronically signing said receipt with a public signature key assigned to an issuer issuing said receipt.

7. The method according to claim 6, further including the steps of performing said requested transaction, and returning said receipt to said sender.

8. The method according to claim 6, wherein said sender uses an anonymous communication connection.

9. The method according to claim 6, wherein said sender uses a pseudonym for communicating.

10. The method according to claim 6, wherein said reference to a designated owner is a pseudonym used by said designated owner.

11. The method according to claim 6, wherein said designated owner of the receipt is the sender.

12. The method according to claim 6, wherein said reference to a designated owner is a public signature key associated to a private signature verification key held by said designated owner of said receipt.

13. A method for proving ownership of a receipt, the method comprising proving ownership of said receipt in a communication system providing a public key encryption infrastructure, including the steps of:
creating a first message including a transaction request and a reference to a designated owner of a receipt to be generated in response to receiving said message;
electronically signing said message using a first private signature key;
sending said first message to a first addressee; and
receiving said receipt from said first addressee, said receipt being electronically signed by said first addressee having given said receipt using a private signature key assigned to said first addressee, wherein said receipt includes information as for what said receipt has been issued and said reference to said designated owner of said receipt.

14. The method according to claim 13, further comprising:
creating a second message including said receipt;
electronically signing said second message using a second private signature key; and
sending said second message to a second addressee;

15. The method according to claim 13, wherein the first addressee is identical to the second addressee.

16. The method according to claim 13, wherein the first private signature key is identical to the second private signature key.

17. The method according to claim 13, wherein said reference to said designated owner of said receipt is a pseudonym used by said owner of the receipt.

18. The method according to claim 13, wherein said reference to said designated owner of said receipt is a public signature verification key associated to a private signature key held by said owner of said receipt.

19. The method according to claims 13, wherein said designated owner of said receipt is identical to a sender sending said first message to the first addressee.

20. The method according to claim 13, further comprising:
creating a second message including said receipt;
electronically signing said second message using a second private signature key; and
sending said second message to said designated owner of said receipt.

21. The method according to claim 13, wherein said steps of sending and receiving of the first message and second message is performed over an anonymous communication connection.

22. The method according to claim 13, wherein said sending and receiving of the first message and second message is performed by using a pseudonym.

23. A computer program product stored on a computer usable medium, comprising computer readable program means for causing a computer to perform a method according to claim 1.

24. A verification device comprising:
means for receiving a message from a sender, said message is electronically signed by said sender using a private signature key owned by said sender, said message includes a receipt which is electronically signed by an issuer having given said receipt using a private signature key assigned to said issuer, wherein said receipt includes details for what said receipt has been given and a reference to an owner of said receipt;
means for obtaining a public signature verification key on the basis of said reference to said owner of said receipt; and
means for examining whether or not said private signature key used for electronically signing said message is associated to said public signature verification key obtained on the basis of said reference to said owner of said receipt, said device being for verifying ownership of said receipt in a communication system providing a public key encryption infrastructure.

25. A receipt generating device comprising:
means for receiving a message from a sender, said message is electronically signed by said sender using a private signature key owned by said sender, whereby said message includes a transaction request and a reference to a designated owner of a receipt to be generated;
means for authenticating said message using a public signature verification key associated to said private signature key held by said sender of said message;
means for issuing a receipt including said reference to said designated owner of said receipt and details for what said receipt has been given; and
means for electronically signing said receipt with a public signature key assigned to an issuer issuing said receipt, said device being for generating said receipt in a communication system providing a public key encryption system.

26. A device for proving ownership of a receipt, said device comprising:
means for creating a first message including a transaction request and a reference to a designated owner of the receipt to be generated in response of receiving said message;
means for electronically signing said message using a first private signature key;
means for sending said first message to a first addressee;
means for receiving a receipt from said first addressee, which is electronically signed by said first addressee having given said receipt using a private signature key assigned to said first addressee, wherein said receipt includes information related to a purpose for which said receipt has been given, and related to said reference to said designated owner of said receipt,
said device being for proving ownership of the receipt in a communication system providing a public key encryption infrastructure.

27. A computer program product stored on a computer usable medium, comprising computer readable program means for causing a computer to perform a method according to claim 6.

28. A computer program product stored on a computer usable medium, comprising computer readable program means for causing a computer to perform a method according to claim 13.

29. A program storage device readable by machine, tangibly embodying a program of instructions executable by the machine to perform method steps for [DESCRIPTION OF GENERAL FUNCTION], said method steps comprising:

30. A program storage device readable by machine, tangibly embodying a program of instructions executable by the machine to perform method steps for verification, said method steps comprising the steps of claim 1.

31. A program storage device readable by machine, tangibly embodying a program of instructions executable by the machine to perform method steps for receipt generation, said method steps comprising the steps of claim 6.

32. A program storage device readable by machine, tangibly embodying a program of instructions executable by the machine to perform method steps for proving ownership of a receipt, said method steps comprising the steps of claim 13.

33. A computer program product comprising a computer usable medium having computer readable program code means embodied therein for causing receipt verification, the computer readable program code means in said computer program product comprising computer readable program code means for causing a computer to effect the functions of the device in claim 24.

34. A computer program product comprising a computer usable medium having computer readable program code means embodied therein for causing receipt generation, the computer readable program code means in said computer program product comprising computer readable program code means for causing a computer to effect the functions of the device in claim 25.

35. A computer program product comprising a computer usable medium having computer readable program code means embodied therein for causing proof of receipt ownership, the computer readable program code means in said computer program product comprising computer readable program code means for causing a computer to effect the functions of the device in claim 26.
